(19) United States
(12) Patent Application Publication
(10) Pub. No.: US 2023/0009797 A1
(43) Pub. Date: Jan. 12, 2023

(54) METHOD AND DEVICE FOR MEASURING THE ALTITUDE OF AN AIRCRAFT IN FLIGHT RELATIVE TO AT LEAST ONE POINT ON THE GROUND

(71) Applicant: THALES, Courbevoie (FR)

(72) Inventors: Rodolphe COTTRON, Mérignac (FR); Pascal CORNIC, Brest (FR); Yoan VEYRAC, Mérignac (FR)

(21) Appl. No.: 17/782,065

(22) PCT Filed: Dec. 3, 2020
(86) PCT No.: PCT/EP2020/084529

§ 371 Date: Jun. 2, 2022

(30) Foreign Application Priority Data
Dec. 4, 2019 (FR) 19 13706

(51) Int. Cl. G01S 13/88; G01S 13/933; G01S 13/95; G01S 13/91

(52) U.S. Cl. CPC G01S 13/882; G01S 13/933; G01S 13/953; G01S 13/913

(57) ABSTRACT

A method and a device for measuring altitude of an aircraft relative to a point on the ground, said aircraft carrying a radar system comprising a directional antenna to transmit a radio frequency signal along a aiming axis, including.
controlling the transmission of a radiofrequency signal along the axis,
calculating received powers as a function of radial distance on a sum channel and an elevation deviation channel,
calculating tilt angular deviation values,
determining an estimator of the radial distance of the aircraft relative to the point on the ground intercepted by the aiming axis as a function of at least one zero crossing of the angular deviation measurement in a selected area of the angular deviation measurement curve,
calculating an aircraft altitude relative to said point on the ground as a function of the estimator of the radial distance and the elevation angle of the aiming axis.

### CROSS-REFERENCE TO RELATED APPLICATIONS

This application is a National Stage Entry of International Patent Application No. PCT/EP2020/084529, filed on Dec. 3, 2020, which claims priority to French Application No. 1913706, filed on Dec. 4, 2019. The disclosures of the priority applications are incorporated in their entirety herein by reference.

### FIELD OF THE INVENTION

The present invention relates to a method and a device for measuring the altitude of an aircraft in flight relative to at least one point on the ground, located in front of the aircraft, for example.

The invention is in the field of aircraft navigation.

### BACKGROUND OF THE INVENTION

In this field, in certain phases of flight such as the landing phase, in particular, it is important to locate an aircraft precisely relative to the ground, and more particularly to know the relative aircraft altitude, relative to the ground.

To do this, aircraft are equipped with various altitude measurement devices, such as an altimeter that makes it possible to evaluate the aircraft altitude, as well as one or more receivers of positioning signals emitted by satellites, such as a GPS receiver, to obtain a geolocated position of the aircraft in real time.

In the landing phase, it is useful to know not only the vertical aircraft altitude in flight, but also its altitude relative to the ground, in particular located in front of the aircraft, such as relative to the landing strip. This problem is all the more critical if the terrain in front of the runway is not flat.

A GPS receiver can be subject to interference, intentional or not, which disrupts the calculation of a geolocated position of the aircraft. Moreover, even when a geolocated position of the aircraft is obtained within a given reference frame, the calculation of the altitude relative to the ground requires very precise terrain maps with associated altitude indications.

It is known to equip an aircraft with a radar system comprising at least one directional antenna, adapted to emit at least one beam of radio frequency waves along a aiming axis in a controllable direction, with said direction being defined by an angle of elevation and a bearing angle. The bearing angle is oriented towards the front of the aircraft, for example. Knowing the elevation angle of the line of sight, it is theoretically possible to calculate the aircraft altitude relative to a point on the ground intercepted by the aiming axis from the radial distance between the antenna and the ground point. However, in order to obtain a precise altitude value, it is necessary to obtain a precise radial distance value, which is particularly difficult since radar measurements are noisy and the wave beam received, as an echo of the transmitted wave beam, comes from an area on the ground illuminated by the beam that is extensive. One problem to be solved is thus estimating such a radial distance precisely.

The object of the invention is to make measurement of the aircraft altitude relative to a point on the ground possible by an automatic process, in an autonomous way, without requiring the presence of reflectors or beacons on the ground.

### SUMMARY OF THE INVENTION

To this end, the invention proposes a method for measuring the altitude of an aircraft in flight relative to at least one point on the ground, said aircraft carrying a radar system comprising at least one directional antenna, adapted to transmit at least one radiofrequency signal along an aiming axis in a controllable direction, said direction being defined by an elevation angle and a bearing angle, and to receive a reflected radiofrequency signal. The method includes the following steps, implemented by a computing processor:
a) controlling transmission of a radiofrequency signal along an aiming axis having a predetermined elevation angle,
b) calculating received powers as a function of a radial distance on two receiving channels comprising a first channel, called the sum channel, and a second channel, called the elevation deviation channel,
c) calculating angular deviation values as a function of the radial distance forming an angular deviation curve,
d) determining an estimator of the radial distance of the aircraft relative to the point on the ground intercepted by the aiming axis as a function of at least one zero crossing of the angular deviation measurement in a selected area of the angular deviation measurement curve,
e) calculating an aircraft altitude of the relative to said point on the ground intercepted by the aiming axis as a function of the estimator of the radial distance and the elevation angle of the aiming axis.

Advantageously, the method of the invention makes it possible to precisely estimate a radial distance of the aircraft from the ground along the aiming axis, and from this to deduce an aircraft altitude relative to the point on the ground intercepted by the aiming axis.

The method for measuring the altitude of an aircraft in flight according to the invention may also have one or more of the features below, taken independently or in any technically conceivable combination. The method further comprises a calculation of a barycenter radial distance, corresponding to a barycenter associated with a power curve received on the sum channel.

The selected area of the angular deviation curve is defined by a distance interval. including said radial barycenter distance, and in which the received power on the sum channel is greater than the received power on the elevation deviation channel.

Determining an estimator of the radial distance of the aircraft from the ground point intercepted by the aiming axis comprises determining a zero crossing of the angular deviation curve in said selected area, said zero crossing corresponding to a radial zero crossing distance, said estimator being equal to said radial zero crossing distance.

The method further comprises applying filtering to determine said radial distance estimator of the aircraft from the point on the ground intercepted by the aiming axis.

The filtering consists of calculating an average value of the radial distances of said selected area of the angular deviation curve, corresponding to angular deviation values lower than a predetermined threshold deviation value.

The filtering consists of calculating a median value of the radial distances of said selected area of the angular deviation curve, corresponding to angular deviation values lower than a predetermined threshold deviation value.

The method comprises controlling the transmission of radio frequency signals along several aiming axes simultaneously, wherein said steps b) to e) are performed for each of said aiming axes, so as to obtain an altitude profile for a plurality of points on the ground respectively intercepted by each of said aiming axes.

According to another aspect, the invention relates to a computer program comprising software instructions that implement an aircraft altitude measurement method, as briefly described above, when implemented by a programmable electronic device.

According to another aspect, the invention relates to a device for measuring the altitude of an aircraft in flight relative to at least one point on the ground, said aircraft carrying a radar system comprising at least one directional antenna, adapted to transmit at least one radiofrequency signal along a aiming axis in a controllable direction, said direction being defined by an elevation angle and a bearing angle, and to receive a reflected radiofrequency signal, the device comprising at least one computing processor, configured to implement:
a module for controlling the transmission of a radio frequency signal along an aiming axis having a predetermined elevation angle.
a module for calculating received powers as a function of a radial distance on two reception channels comprising a first channel, called the sum channel, and a second channel, called the deviation channel,
a module for calculating angular deviation values as a function of radial distances forming an angular deviation curve,
a module for determining an estimator of the radial distance of the aircraft relative to the ground point intercepted by the aiming axis as a function of at least one zero crossing of the angular deviation measurement in a selected area of the angular deviation measurement curve,
a module for calculating an aircraft altitude relative to said point on the ground intercepted by the aiming axis as a function of the estimator of the radial distance and the elevation angle of the aiming axis.

### BRIEF DESCRIPTION OF THE DRAWINGS

Further features and advantages of the invention will be apparent from the description given below, by way of indication and not in any way limiting, with reference to the appended figures, of which:

FIG. 1 schematically illustrates an application of the invention;

FIG. 2 is a block diagram of the main functional blocks of a device for measuring the altitude of an aircraft according to an embodiment of the invention;

FIG. 3 is an example of a graph representing curves of received power on two channels as a function of radial distance;

FIG. 4 is a flowchart of the main steps of an aircraft altitude measurement process according to an embodiment of the invention, and

FIG. 5 is an example of a graph representing the angular deviation value as a function of radial distance.

### DETAILED DESCRIPTION OF EMBODIMENTS

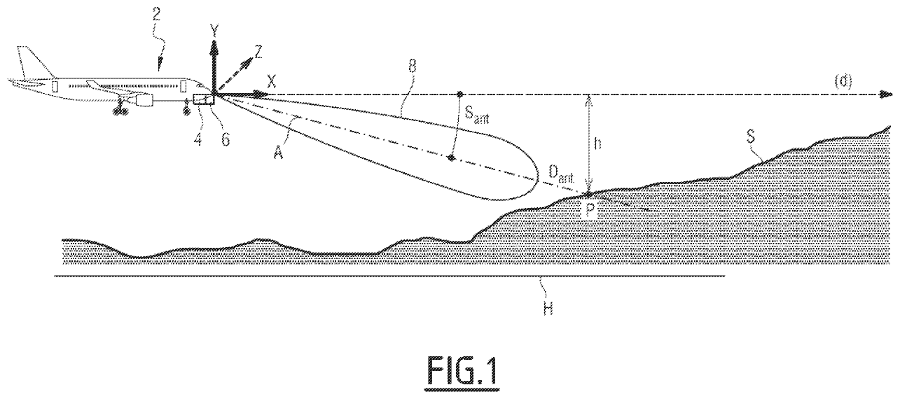

FIG. 1 schematically illustrates an embodiment of the invention, and provides a geometric description of the application context of the invention.

In the example shown in FIG. 1, an aircraft 2, such as an airplane, is shown in flight and moving in a direction (d) represented by a dashed arrow. In the illustrated schematic example, the direction (d) is parallel to the horizontal plane.

The aircraft 2 is shown in FIG. 1 in a case where it flies over a terrain S, which is irregular and steep.

The aircraft 2 is equipped with a radar system 4, comprising at least one directional antenna 6, adapted to emit a beam of radio frequency waves or radio frequency signal 8, along an aiming axis A in a controllable direction.

For example, in one embodiment, the radar system 4 is fixed to the front of the aircraft.

The direction of the aiming axis A is classically defined by two angles in the orthogonal reference frame (X, Y, Z) shown in FIG. 1, called elevation angle and bearing angle respectively.

In the example of FIG. 1, the aircraft 2 is moving in a horizontal plane (X, Z), so the aircraft fuselage axis is in the horizontal plane.

The elevation angle Sant is the angle formed between the aiming axis A and the horizontal plane (X, Z). The bearing angle formed between the aiming axis A and the vertical plane (Y, Z), is not shown in FIG. 1.

The aiming axis A of the antenna 6 of the onboard radar system 4 intercepts the ground S at a point P, hereafter called the interception point relative to the aiming axis A.

The method of the invention makes it possible to obtain a precise and robust estimate of the radial distance Dant between the phase center of the transmitting antenna 6 and the point P, on the one hand, and, on the other hand, to deduce from this a measurement of the altitude h at the point P, the distance, vertically from the point P, between the point P and the horizontal plane passing through a reference point of the aircraft, such as the barycenter of the aircraft.

In a simple way, the following geometrical relation is verified:

h=Dₐₙₜ×sin (Sₐₙₜ) [Math 1]

where sin( ) is the trigonometric sine function, Dₐₙₜ is the radial distance value at the estimated intercept point and Sₐₙₜ is the elevation angle value.

Precisely estimating the radial distance Dₐₙₜ in the fixed elevation angle direction Sₐₙₜ is difficult, since the radio wave beam 8 intercepts an area on the ground around the intercept point P and the radar system thus receives reflected radio waves corresponding to all directions within the beam 8.

In a known manner, the antenna radiation pattern representing the received power as a function of the estimated radial distance comprises several lobes, and the power is not maximum in the direction of the main lobe. In other words, such an antenna radiation pattern is insufficient for obtaining a robust estimate of the radial distance.

Furthermore, it should be noted that the power measurements may be noisy, which increases the difficulty of estimating the radial distance Dₐₙₜ.

The method of the invention proposes computing an estimator of the radial distance of the aircraft from the ground along the aiming axis.

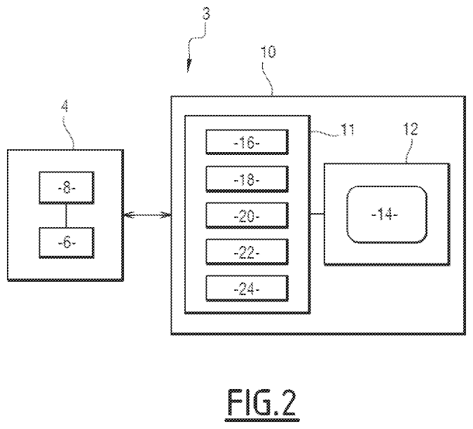

FIG. 2 illustrates one embodiment of an onboard system 3 for measuring the altitude of an aircraft in flight according to one embodiment of the invention.

The onboard system 3 comprises an onboard radar system 4 and a device 10 for measuring the altitude of an aircraft relative to at least one point on the ground, other than a point located at right angles to the vertical of the aircraft.

The radar system 4 comprises at least one directional antenna 6, whose transmission direction is controllable by a control unit 8.

For example, the radar system is a mechanically scanned system, and the control unit 8 is a motor adapted to turn the directional antenna in the selected direction.

In a variant, the radar system 4 is an electronically scanned DFB (Digital Beam Forming) or MIMO radar system.

The radar system 4 has at least two reception channels, which are respectively a first reception channel, called sum channel, and a second reception channel, called elevation deviation channel.

These reception channels are known in the field of radars, and particularly in the field of single pulse radars.

The sum channel, hereafter called the S channel, is a reception channel on which the signals received in each reception unit (such as in each quadrant) of a reception antenna are added.

For example, a power curve associated with the sum channel represents corresponding power values as a function of measured radial distance values. Each measured distance value corresponds to a sampling time t(i) of the radio frequency signal, converted to radial distance d(i) by the formula:

$$d ( i ) = \frac{c \times t ( i )}{2} \qquad [ Math 2 ]$$

Where c is the speed of light.

The elevation deviation channel, hereafter called the E channel, is a reception channel on which signals received by some reception units (such as the top two quadrants of a 4-quadrant antenna) of a reception antenna are subtracted from other reception units (such as the bottom two quadrants of a 4-quadrant antenna) of the reception antenna.

For example, a power curve associated with channel E represents the power values of the radio frequency signal received on channel E for each radial distance d(i) as defined above.

The powers calculated as a function of radial distance for each of the reception channels are transmitted to an onboard aircraft altitude measurement device 10, according to one embodiment.

The device 10 is a programmable electronic device, such as an onboard computer.

The device 10 comprises an electronic computing unit 11, comprising one or more processors, configured to implement computing modules described in more detail below. It also comprises an electronic memory unit 12, configured to store data, such as altitude measurements 14 in association with ground intercept points, forming an altitude profile of a spatial area of the ground, for example, as described in more detail below.

The calculation modules include in particular a module 16 for calculating the powers as a function of the radial distance for the two reception channels, a module 18 for calculating the angular deviation in elevation, a module 20 for calculating a barycenter associated with the powers received from channel S, a module 22 for calculating a radial distance estimator, and a module 24 for calculating the aircraft altitude relative to a point on the ground corresponding to the estimated radial distance

As explained in more detail below, the module 22 for calculating a radial distance estimator implements a determination of zero-crossing the angular deviation measurement in an area defined by an interval of radial distances, chosen as a function of the powers on the two reception channels, and the radial distance of barycenter calculated by the barycenter calculation module 20.

In one embodiment, each of these modules is implemented as software, comprising code instructions executable by the computing unit 11 when the device 10 is powered on.

According to one embodiment, the programmable electronic device 10 is implemented as an ASIC or FPGA type of programmed board.

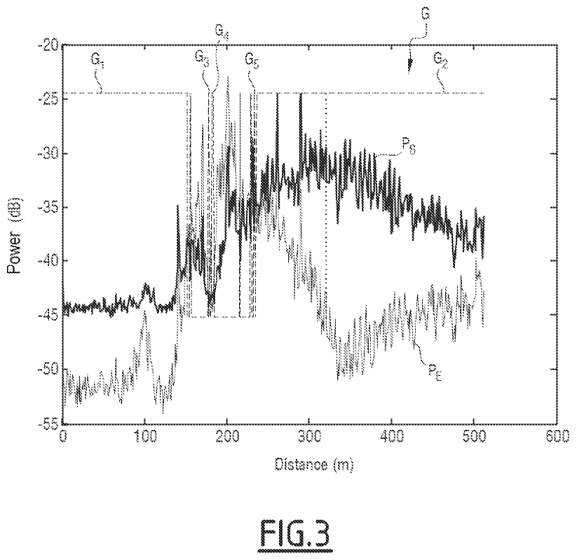

FIG. 3 illustrates an example of received power curves P_{S}, P_{E} associated with respective channels S and E as a function of radial distances. The graph in FIG. 3 represents the power in decibels on the ordinate, as a function of the distance in meters on the abscissa.

In addition, a curve G includes areas G₁ to G₅, in which the power values of the channel S are greater than the power values of channel E, are shown in FIG. 3. It is clear from the Figure that the power curves P_{S}, P_{E} obtained in this way are noisy and that it is difficult to obtain a precise assessment of the radial distance corresponding to the aiming axis.

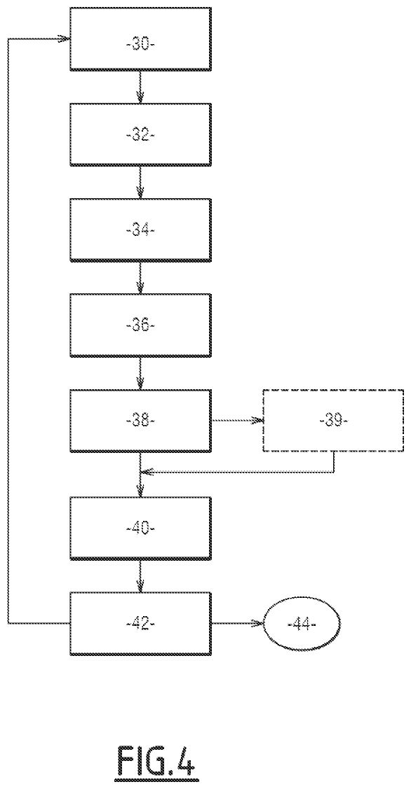

FIG. 4 is a flowchart of the main steps of a method for measuring the altitude of an aircraft according to one embodiment of the invention.

The method comprises a first step 30 of controlling the setting of an elevation angle value, Sₐₙₜ for the aiming axis orientation of a directional antenna of an aircraft-borne radar system (airborne radar system).

Then, in a power calculation step 32, received power values are calculated and stored, as a function of radial range, for a range interval, with a predetermined sampling step, for each of the first channel (sum channel) and second channel (elevation deviation channel).

In a variant, in one embodiment, the power is calculated by averaging the powers from received radio frequency signals coming from multiple bearing antenna pointing, within a few degrees.

The step 32 of calculating the powers of the received radio frequency signals is followed by a step 34 of calculating the angular deviation values as a function of the distance, forming an angular deviation curve. The angular deviation calculation is taken, in a known way, from the amplitudes of the signals received on the sum channel and the elevation deviation channel respectively.

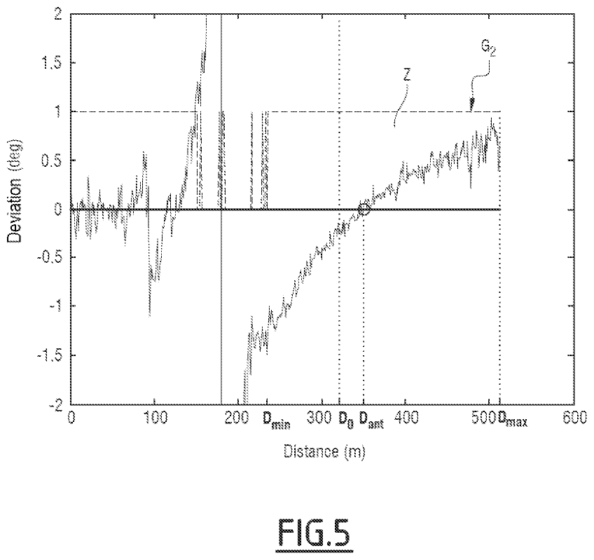

One example of an angular deviation curve, corresponding to the power curves of FIG. 3, is shown in FIG. 5.

The elevation angular deviation is expressed in degrees (ordinate of the graph shown in FIG. 5), as a function of the radial distance expressed in meters.

In a variant, the elevation angular deviation in the field is calculated by averaging the elevation angular deviations from multiple bearing antenna pointing, within a few degrees.

The method further comprises a step 36 of calculating a barycenter associated with the sum channel, making it possible to obtain a barycenter radial distance value Do.

The radial barycenter distance is calculated from the powers calculated for the sum channel, for example, by the formula:

$${D}_{0} = \frac{{\sum }_{i} d ( i ) \times P s ( i )}{{\sum }_{i} P s ( i )} \qquad [ Math 3 ]$$

where i is the distance box index, d(i) is the radial distance for the distance box of index i (according to the formula [Math 2] and Ps(i) is the power of the Sum path for the distance box of index i.

Advantageously, the barycenter associated with the sum channel belongs to the main lobe of the antenna pattern of the onboard radar system antenna.

The method further comprises a determination 38 of the radial distance(s) for which the angular deviation value is equal to zero in a selected area of the angular deviation curve.

The selected area is one of the areas Gᵢ in which the power received on the sum channel (S channel) is greater than the power received on the elevation deviation channel (E channel), and more particularly the area defined by an interval of distances [Dₘᵢₙ, Dₘₐₓ], including the barycenter radial distance D₀ calculated in the barycenter calculation step 36.

The distance Dₘₐₓ is the greatest distance of the area in which the power received on the sum channel is greater than the power received on the elevation deviation channel, and including the radial barycenter distance D₀.

The distance Dₘₐₓ is the estimated maximum radial distance, in one embodiment.

In FIG. 5, as an example, the selected area Z has been illustrated, as well as the distances Dₘᵢₙ, Dₘₐₓ and the radial distance of barycenter D₀ on the x-axis. The chosen area Z corresponds to the area G2 in FIG. 3.

The radial distance value corresponding to the zero crossing of the angular deviation measurement in the chosen area Z is an estimator of the radial distance Dₐₙₜ of the aircraft relative to the ground along the aiming axis.

In one embodiment, the method further comprises, in the event that multiple zero crossings of the angular deviation are detected in the selected area, filtering (step 39) the corresponding radial distance values to determine the radial distance estimator.

For example, the filtering implemented in the filtering step 39 consists in calculating the average value of the radial distances values corresponding angular deviation values lower in absolute value than a predetermined threshold deviation value, that is, comprised between −ε and ε, with ε being worth a fraction of the antenna aperture in elevation, preferably a few tenths of the antenna aperture in elevation, equal to 0.1°, for example.

According to one embodiment, the filtering consists in selecting the median value of the radial distances corresponding to angular deviation values lower in absolute value than a predetermined threshold deviation value, comprised between −ε and ε.

According to another embodiment, in step 38 of determining a zero crossing of the angular deviation in the selected angular deviation area, a polynomial regression (of degree 1 or higher) is applied.

The method further includes a step 40 of calculating an aircraft altitude as a function of the radial distance estimator Dₐₙₜ and the elevation angle Sₐₙₜ of the aiming axis, by applying the formula explained above [Math 1], with the elevation angle Sₐₙₜ fixed.

The aircraft altitude value associated with the interception point of the line of the sight P on the ground is stored at step 42. The interception point P is in a predetermined spatial reference frame defined by coordinates, for example, knowing the position of the aircraft in the spatial reference frame.

In a variant or additionally, knowing the aircraft altitude, it is possible to calculate and store the altitude of the interception point P as a function of the previously calculated altitude.

Optionally, steps 30 to 42 are repeated for several antenna aiming axis directions, and the altitude and/or altitude values relative to the interception points on the ground are stored, which makes it possible to obtain an altitude profile 44 area on the ground illuminated by the radar system, located in front of the aircraft, for example.

When the radar system is beam forming by computing, power measurements for several sighting directions are acquired at the same time, which makes it possible to obtain an instantaneous altitude profile 44 of the area on the ground illuminated by the transmitted wave beam, located in front of the aircraft, for example.

Advantageously, in the landing phase, thanks to the method of the invention, an instantaneous profile of an area on the ground, such as the area located in front of the aircraft, which is a landing strip, for example, is available on board the aircraft. This profile is computed autonomously and the estimated altitudes are precise, with the altitude estimation error being less than one meter.

1. A method for measuring the altitude of an aircraft in flight relative to at least one point on the ground, said aircraft carrying a radar system comprising at least one directional antenna, adapted to transmit at least one radio frequency signal along an aiming axis in a controllable direction, said direction being defined by an elevation angle and a bearing angle, and to receive a reflected radiofrequency signal,
the method being implemented by a computing processor and comprising:
a) controlling the transmission of a radio frequency signal along a aiming axis having a predetermined elevation angle,
b) calculating powers received as a function of a radial distance on two reception channels comprising a first channel, called the sum channel and a second channel, called the elevation deviation channel,
c) calculating tilt angle deviation values as a function of the radial distance forming an angular deviation curve,
d) determining an estimator of the radial distance of the aircraft relative to a point on the ground intercepted by the aiming axis as a function of at least one zero crossing of the angular deviation in a selected area of the angular deviation curve, and
e) calculating an aircraft altitude relative to said ground point intercepted by the aiming axis as a function of the radial distance estimator and the elevation angle of the aiming axis.

2. The method according to claim 1, further comprising computing a barycenter radial distance corresponding to a barycenter associated with a received power curve on the sum channel.

3. The method according to claim 2, wherein said selected angular deviation curve area is defined by a distance interval containing said radial barycenter distance, and wherein the power received on the sum channel is greater than the power received on the elevation deviation channel.

4. A method according to claim 1, wherein the determination of the estimator of the radial distance of the aircraft from the point on the ground intercepted by the aiming axis comprises a determination of a zero-crossing of the angular deviation curve in said selected area, said zero-crossing corresponding to a radial zero-crossing distance, said estimator being equal to said radial zero-crossing distance.

5. The method according to claim 1, further comprising applying filtering to determine said radial distance estimator of the aircraft from the point on the ground intercepted by the aiming axis.

6. The method according to claim 5, wherein said filtering comprises calculating an average value of the radial distances of said selected area of the angular deviation curve, corresponding to angular deviation values less than a predetermined threshold deviation value.

7. The method according to claim 5, wherein said filtering comprises calculating a median value of the radial distances of said selected area of the angular deviation curve, corresponding to angular deviation values less than a predetermined threshold deviation value.

8. The method according to claim 1, comprising a command to transmit radio frequency signals along several aiming axis axes simultaneously, and wherein said steps b) to e) are carried out for each of said aiming axis axes, so as to obtain an altitude profile of a plurality of points on the ground respectively intercepted by each of said aiming axes.

9. A non-transitory memory storing a computer program comprising software instructions which, when implemented by a programmable electronic device, implement an aircraft altitude measurement method according to claim 1.

10. A device for measuring the altitude of an aircraft in flight relative to at least one point on the ground, said aircraft carrying a radar system comprising at least one directional antenna, adapted to transmit at least one radio frequency signal along an aiming axis in a controllable direction, said direction being defined by an elevation angle and a bearing angle, and to receive a reflected radio frequency signal,
the device comprising at least one calculation processor configured to implement:
a. a module configured to control the transmission of a radio frequency signal along an aiming axis having a predetermined elevation angle,
b. a module configured to calculate received powers as a function of a radial distance on two reception channels comprising a first channel called the sum channel and a second channel called the deviation channel,
c. a module configured to calculate angular deviation values as a function of radial distances forming an angular deviation curve,
d. a module configured to determine an estimator of the radial distance of the aircraft relative to the point on the ground intercepted by the aiming axis as a function of at least one zero crossing of the angular deviation in a selected area of the angular deviation curve, and
e. a module configured to calculate an aircraft altitude relative to said point on the ground intercepted by the aiming axis as a function of the estimator of the radial distance and the elevation angle of the aiming axis.

11. The device according to claim 10, further comprising a barycenter calculation module, configured to calculate a barycenter radial distance corresponding to a barycenter associated with a received power curve on the sum channel, said selected area of the angular deviation curve defined by a distance interval comprising said barycenter radial distance, and wherein the received power on the sum channel is greater than the received power on the deviation elevation channel.
